(19) United States
(12) Patent Application Publication
(10) Pub. No.: US 2009/0104508 A1
(43) Pub. Date: Apr. 23, 2009

(54) Membrane electrode assembly for fuel cell, preparing method for same, and fuel cell system including same

(76) Inventor: Han-Kyu Lee, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/075,555

(22) Filed: Mar. 11, 2008

(30) Foreign Application Priority Data
Oct. 19, 2007 (KR) 10-2007-0105750

(51) Int. Cl. H01M 4/88; H01M 8/10; H01M 4/90

(52) U.S. Cl. 429/40; 429/30; 427/115

(57) ABSTRACT

The membrane-electrode assembly for a fuel cell according to an embodiment includes an anode and a cathode facing each other, and a polymer electrolyte membrane interposed therebetween. At least one of the anode and cathode includes an electrode substrate, a microporous layer disposed on the electrode substrate, and a catalyst layer disposed on the microporous layer. The catalyst layer includes a catalyst and a binder resin, and the binder resin has an average chain length ranging from about 5 to about 30 nm. According to the embodiment, a membrane-electrode assembly can be easily prepared without firing and can be prevented from distorting, improving cell characteristics.

### CROSS-REFERENCE TO RELATED APPLICATION

This application claims priority to and the benefit of Korean Patent Application No. 10-2007-0105750 filed in the Korean Intellectual Property Office on Oct. 19, 2007, the entire content of which is incorporated herein by reference.

### BACKGROUND OF THE INVENTION

1. Field of the Invention

The present embodiments relate to a membrane-electrode assembly for a fuel cell, a method for preparing the same, and a fuel cell system including the same. More particularly, the present embodiments relate to a membrane-electrode assembly that does not catch fire during the manufacturing processes, and that can inhibit distortion of a polymer electrolyte membrane resulting in improvement of fuel cell performance, a method for manufacturing the same, and a fuel cell system including the same.

2. Description of the Related Art

A fuel cell is a power generation system for producing electrical energy through an electrochemical redox reaction of an oxidant and hydrogen in a hydrocarbon-based material such as methanol, ethanol, or natural gas.

Such a fuel cell is a clean energy source that can replace fossil fuels. It includes a stack composed of unit cells, and produces various ranges of power. Since it has a four to ten times higher energy density than a small lithium battery, it has been high-lighted as a small portable power source.

Representative exemplary fuel cells include a polymer electrolyte membrane fuel cell (PEMFC) and a direct oxidation fuel cell (DOFC). The direct oxidation fuel cell includes a direct methanol fuel cell that uses methanol as a fuel.

The polymer electrolyte fuel cell has an advantage of high energy density and high power, but it also has problems in the need to carefully handle hydrogen gas and the requirement for accessory facilities such as a fuel reforming processor for reforming methane, methanol, natural gas, and the like in order to produce hydrogen as the fuel gas.

A direct oxidation fuel cell has lower energy density than that of the polymer electrolyte fuel cell, but has the advantages of easy handling of the polymer electrolyte fuel cell, a low operation temperature, and no need for additional fuel reforming processors.

In the above-mentioned fuel cell system, a stack that generates electricity substantially includes several to scores of unit cells stacked adjacent to one another, and each unit cell is formed of a membrane-electrode assembly (MEA) and a separator (also referred to as a bipolar plate). The membrane-electrode assembly is composed of an anode (also referred to as a “fuel electrode” or an “oxidation electrode”) and a cathode (also referred to as an “air electrode” or a “reduction electrode”) that are separated by a polymer electrolyte membrane.

A fuel is supplied to an anode and adsorbed on catalysts of the anode, and the fuel is oxidized to produce protons and electrons. The electrons are transferred into a cathode via an external circuit, and the protons are transferred into the cathode through the polymer electrolyte membrane. In addition, an oxidant is supplied to the cathode, and then the oxidant, protons, and electrons are reacted on catalysts of the cathode to produce electricity along with water. The present embodiments overcome the above problems and provide additional advantages as well.

### SUMMARY OF THE INVENTION

One embodiment provides a membrane-electrode assembly for a fuel cell that does not catch fire during the manufacturing processes, and that can inhibit distortion of a polymer electrolyte membrane resulting in improvement of a fuel cell performance.

Another embodiment provides a method of manufacturing the membrane-electrode assembly for a fuel cell.

Yet another embodiment provides a fuel cell system including the membrane-electrode assembly.

According to an embodiment, provided is a membrane-electrode assembly for a fuel cell that includes an anode and a cathode facing each other, and a polymer electrolyte membrane interposed therebetween. At least one of the anode and cathode includes an electrode substrate, a microporous layer disposed on the electrode substrate, and a catalyst layer disposed on the microporous layer. The catalyst layer includes a catalyst and a binder resin, and the binder resin has an average chain length ranging from 5 to 30 nm.

According to one embodiment, the binder resin has an average chain length ranging from 7 to 20 nm.

The binder resin is a water-soluble binder, and has a cation exchange group selected from the group consisting of a sulfonic acid group, a carboxylic acid group, a phosphoric acid group, a phosphonic acid group, and derivatives thereof, at its side chain.

The catalyst may be a platinum-based catalyst selected from the group consisting of platinum, ruthenium, osmium, platinum-ruthenium alloys, platinum-osmium alloys, platinum-palladium alloys, platinum-M alloys where M is a transition element such as, for example, Ga, Ti, V, Cr, Mn, Fe, Co, Ni, Cu, Zn, Sn, Mo, W, Ru, Rh, combinations thereof, and mixtures thereof.

The catalyst may be supported on a carrier selected from the group consisting of a carbon-based material, an inorganic material particulate, and mixtures thereof.

The catalyst layer further includes a non-conductive compound.

The microporous layer may include conductive powders selected from the group consisting of carbon powders, carbon black, acetylene black, activated carbon, carbon fiber, fullerene, carbon nanotubes, carbon nanowire, carbon nanohoms, carbon nanorings, and mixtures thereof.

The electrode substrate is a conductive substrate selected from the group consisting of carbon paper, carbon cloth, carbon felt, metal cloth, and combinations thereof.

The electrode substrate is subjected to a water-repellent treatment with a fluorinated resin.

The polymer electrolyte membrane includes a polymer resin having a cation exchange group selected from the group consisting of a sulfonic acid group, a carboxylic acid group, a phosphoric acid group, a phosphonic acid group, and derivatives thereof, at its side chain.

According to another embodiment, provided is a method of manufacturing a membrane-electrode assembly for a fuel cell that includes forming a microporous layer on an electrode substrate; forming a hydrophilic organic compound layer on the microporous layer; forming a catalyst layer on the hydrophilic organic compound layer; subjecting the electrode substrate to heat treatment to remove a hydrophilic organic compound layer; and assembling the electrode substrate without the hydrophilic organic compound layer and a polymer electrolyte membrane.

The hydrophilic organic compound layer can be formed by impregnating an electrode substrate with a microporous layer in a hydrophilic organic compound and then drying it, or coating a hydrophilic organic compound on an electrode substrate with a microporous layer and then drying it.

The hydrophilic organic compound may have viscosity ranging from 0.7 to 1.3 N·s/m².

The hydrophilic organic compound may be selected from the group consisting of polyhydric alcohols with more than two hydroxyl groups, a glycol derivative, hyaluronic acid, and mixtures thereof.

The hyaluronic acid may have a weight-average molecule weight (Da) ranging from 250,000 to 350,000.

The hydrophilic organic compound layer may include a hydrophilic organic compound in an amount of from about 0.3 mg/cm² to about 0.9 mg/cm² on a microporous layer.

The composition for a catalyst layer may include a catalyst, a binder resin, and an aqueous solvent.

The aqueous solvent may include water.

The heat treatment may be performed at a temperature ranging from 160° C. to 190° C.

The heat treatment may be performed under a vacuum atmosphere.

The electrode substrate may be selected from the group consisting of carbon paper, carbon cloth, carbon felt, metal cloth, and combinations thereof.

The electrode substrate may have a water-repellent treatment with a fluorine-based resin.

According to yet another embodiment, provided is a fuel cell system including an electricity generating element that includes the above membrane-electrode assembly and a separator positioned at each side of the membrane-electrode assembly, a fuel supplier that supplies the electricity generating element with a fuel, and an oxidant supplier that supplies the electricity generating element with an oxidant.

### BRIEF DESCRIPTION OF THE DRAWINGS

FIG. 1 is a schematic cross-sectional view showing a membrane-electrode assembly according to an embodiment.

FIG. 2 is a flow chart showing a method of a manufacturing membrane-electrode assembly for a fuel cell according to one embodiment.

FIG. 3 is a schematic diagram showing the structure of a fuel cell system according to another embodiment.

FIG. 4 is a graph showing measurement results of average chain lengths of binder resins in catalyst layers according to Example 1 and Comparative Example 1.

FIG. 5A is a photograph taken of firing during formation of an anode catalyst layer of a membrane-electrode assembly according to Comparative Example 3 and FIG. 5B is a photograph taken of firing during formation of a cathode catalyst layer of a membrane-electrode assembly according to Comparative Example 3.

### DETAILED DESCRIPTION OF THE INVENTION

A membrane-electrode assembly of a fuel cell is composed of a polymer electrolyte membrane, and an anode and a cathode arranged at each side of the polymer electrolyte membrane. The membrane-electrode assembly generates electricity through oxidation of a fuel and reduction of an oxidant. The reaction of generating electricity at a membrane-electrode assembly actively occurs when the polymer electrolyte membrane has a good interface adhesion to a catalyst layer and also a large contact area at the interface therewith.

A membrane-electrode assembly is prepared by first forming a catalyst layer on a polymer electrolyte membrane and then binding it with an electrode substrate, or forming a catalyst layer on an electrode substrate and then binding it with a polymer electrolyte. The former method can have an advantage of good interface adherence between the catalyst layer and the polymer electrolyte membrane, but problems of prolonged manufacturing time and swelling of the polymer electrolyte membrane due to a solvent included in the composition may occur. As a result, the polymer electrolyte membrane can be distorted, deteriorating the interface adherence between the catalyst layer and the polymer electrolyte membrane.

In addition, the latter method has an advantage of a rapid coating process and no distortion of an electrode substrate. However, even though an electrode substrate needs a water-repellent treatment, it is hard to directly coat a composition for an aqueous catalyst layer on the electrode substrate.

In addition, for a composition for a catalyst layer including an organic solvent, the organic solvent can contribute to dispersion of a catalyst in the composition but can easily cause a fire due to high reactivity with the catalyst.

Therefore, the present embodiments provide a membrane-electrode assembly in which a fire does not occur when an organic solvent is used, that has no distortion, and that can contribute to improved power characteristics, by forming a hydrophilic organic compound layer on an electrode substrate with a microporous layer so that an aqueous composition for a catalyst layer can be used, when a membrane-electrode assembly is prepared.

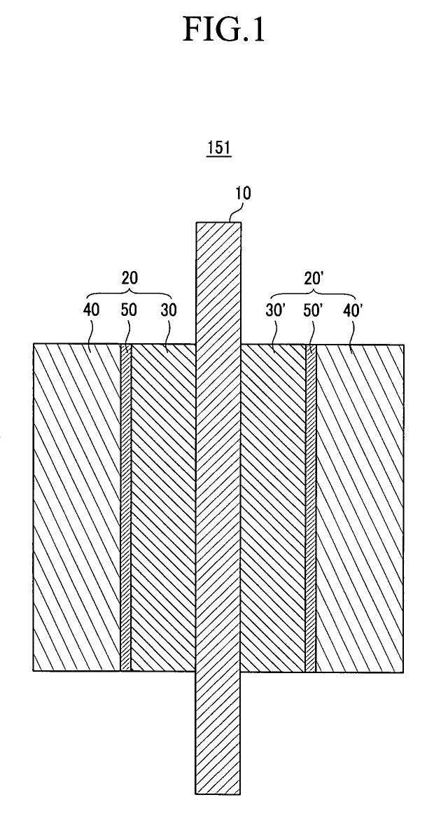

FIG. 1 is a schematic cross-sectional view showing a membrane-electrode assembly according to an embodiment.

Referring to FIG. 1, a membrane-electrode assembly 151 according to one embodiment includes a cathode 20 and an anode 20′ facing each other, and a polymer electrolyte membrane 10 interposed therebetween. At least one of the cathode 20 and the anode 20′ includes catalyst layers 30 and 30′, electrode substrates 40 and 40′ supporting the catalyst layers 30 and 30′, and microporous layers 50 and 50′ disposed between the catalyst layers 30 and 30′ and the electrode substrates 40 and 40′.

In the membrane-electrode assembly 151 , an electrode 20 disposed on one side of a polymer electrolyte membrane 10 is called a cathode, while the other electrode 20′ disposed on the other side of the polymer electrolyte membrane 10 is called an anode. The anode 20′ plays a role of oxidizing a fuel delivered through the electrode substrate 40′ to the catalyst layer 30′, thereby generating protons and electrons. The polymer electrolyte membrane 10 transfers the protons generated from the anode 20′ to the cathode 20. The cathode 20 reduces the protons supplied through the polymer electrolyte membrane 10 and an oxidant delivered through the electrode substrate 40 to the catalyst layer 30, and thereby produces water.

The catalyst layers 30 and 30′ may include a catalyst that promotes the reactions (oxidation of a fuel and reduction of an oxidant).

The catalyst in the catalyst layers 30 and 30′ may include anything that can participate in the reaction of a fuel cell as a catalyst. For example, it may include a platinum-based catalyst. The platinum-based catalyst may be selected from the group consisting of platinum, ruthenium, osmium, a platinum-ruthenium alloy, a platinum-osmium alloy, a platinum-palladium alloy, a platinum-M alloy (M is a transition element such as Ga, Ti, V, Cr, Mn, Fe, Co, Ni, Cu, Zn, Sn, Mo, W, Ru, Rh, and combinations thereof), and mixtures thereof. As aforementioned, the anode and the cathode may include the same material as a catalyst, but in a direct oxidation fuel cell, the anode may include a platinum-ruthenium alloy catalyst to prevent catalyst poisoning due to CO generated during the reaction. More specifically, non-limiting examples of the platinum-based catalyst include Pt, Pt/Ru, Pt/W, Pt/Ni, Pt/Sn, Pt/Mo, Pt/Pd, Pt/Fe, Pt/Cr, Pt/Co, Pt/Ru/W, Pt/Ru/Mo, Pt/Ru/V, Pt/Fe/Co, Pt/Ru/Rh/Ni, Pt/Ru/Sn/W, and mixtures thereof.

Such a metal catalyst may be used in a form of a metal itself (black catalyst), or one supported on a carrier. The carrier may include a carbon-based material such as graphite, denka black, ketjen black, acetylene black, carbon nanotubes, carbon nanofiber, carbon nanowire, carbon nanoballs, and activated carbon, or an inorganic particulate such as alumina, silica, zirconia, and titania. The carbon-based material can be generally used.

The catalyst layers 30 and 30′ may include a binder resin to improve adherence of a catalyst layer and deliver protons, in addition to the catalyst.

In general, a binder resin is used after it is dispersed into an organic solvent. Herein, the binder resin has generally had an average polymer chain length of more than 50 nm.

However, a catalyst layer according to one embodiment is formed by using an aqueous composition for a catalyst layer including an aqueous solvent. Accordingly, a binder resin dispersed in the aqueous solvent has an average polymer chain ranging from about 5 nm to about 30 nm in length. According to another embodiment, it may have an average polymer chain ranging from about 7 to about 20 nm in length, indicating that it is more finely dispersed in the solvent. Since the solvent is aqueous, the binder resin may be water-soluble. In this specification, when specific description is not provided, “an average polymer chain length” of a binder resin refers to an average length of chain including a main chain and a side chain of the binder resin.

The water-soluble binder resin may be a proton conductive polymer resin having a cation exchange group, for example, a sulfonic acid group, a carboxylic acid group, a phosphoric acid group, a phosphonic acid group, and derivatives thereof, at its side chain.

Non-limiting examples of the polymer resin include at least one proton conductive polymer such as, fluoro-based polymers, benzimidazole-based polymers, polyimide-based polymers, polyetherimide-based polymers, polyphenylenesulfide-based polymers, polysulfone-based polymers, polyethersulfone-based polymers, polyetherketone-based polymers, polyetheretherketone-based polymers, and polyphenylquinoxaline-based polymers. In one embodiment, the proton conductive polymer is at least one selected from the group consisting of poly(perfluorosulfonic acid) (commercially available “NAFION®”) (DuPont Inc. Wilmington, Del.), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), or poly (2,5-benzimidazole).

The binder resin may be used singularly or as a mixture. Optionally, the binder resin may be used along with a non-conductive polymer to improve adherence between a polymer electrolyte membrane and the catalyst layer. The amount of the binder resin may be adjusted to its usage purpose.

Non-limiting examples of the non-conductive polymer include polytetrafluoroethylene (PTFE), tetrafluoroethylene-hexafluoropropylene copolymers (FEP), tetrafluoroethylene-perfluoro alkyl vinylether copolymers (PFA), ethylene/tetrafluoroethylene (ETFE)), ethylenechlorotrifluoro-ethylene copolymers (ECTFE), polyvinylidene fluoride, polyvinylidene fluoride-hexafluoropropylene copolymers (PVdF-HFP), dodecyl benzene sulfonic acid, sorbitol, and combinations thereof.

The catalyst layers 30 and 30′ are supported by electrode substrates 40 and 40′.

The electrode substrates 40 and 40′ play a role of supporting an electrode and diffusing a fuel and an oxidant, thereby facilitating easy approach thereof to the catalyst layers 30 and 30′.

The electrode substrates 40 and 40′ may include a conductive substrate, for example carbon paper, carbon cloth, carbon felt, or metal cloth (a porous film fiber made of fiber-like metal or a metal film disposed on the surface of a cloth made of a polymer fiber), but is not limited thereto.

In addition, the electrode substrates 40 and 40′ may be subjected to a water-repellent treatment with a fluorine-based resin, such that the resin can prevent diffusion efficiency of a reactant from deteriorating due to water generated during the operation of a fuel cell. The fluorine-based resin may be selected from the group consisting of polytetrafluoroethylene, polyvinylidene fluoride, polyhexafluoropropylene, polyperfluoroalkylvinylether, polyperfluorosulfonylfluoridealkoxyvinyl ether, fluorinated ethylene propylene, polychlorotrifluoroethylene, a copolymer thereof, and mixtures thereof.

Further, microporous layers 50 and 50′ are inserted between the electrode substrates 40 and 40′ and catalyst layers 30 and 30′.

The microporous layers 50 and 50′ can improve diffusion effects of a reactant at electrode substrates, and can also play a role of preventing a catalyst in an aqueous slurry for a catalyst layer from entering electrode substrates when a membrane-electrode assembly is manufactured.

If a part of a catalyst enters an electrode substrate, it may not contact an electrolyte. As a result, it has a decreased surface area.

The microporous layer may in general include a conductive powder with a small particle diameter, for example carbon powder, carbon black, acetylene black, activated carbon, carbon fiber, fullerene, carbon nanotubes, carbon nanowire, carbon nanohorns, carbon nanorings, and the like.

The microporous layer can include a binder resin in addition to the conductive powder.

The binder resin may include, for example, polytetrafluoroethylene, polyvinylidenefluoride, polyhexafluoropropylene, polyperfluoroalkylvinylether, polyperfluorosulfonylfluoride, alkoxyvinyl ether (polyfluorinated alkoxyvinyl ether), polyvinylalcohol, celluloseacetate, a copolymer thereof, or the like.

The electrodes 20 and 20′ are used to fabricate a membrane-electrode assembly 151. The membrane-electrode assembly 151 also includes a polymer electrolyte membrane 10 disposed between the anode and the cathode.

The polymer electrolyte membrane 10 plays a role of transferring protons produced at the catalyst layer 30′ of the anode 20′ to the other catalyst layer 30 of the cathode 20. Accordingly, the polymer electrolyte membrane 10 includes a polymer with excellent proton conductivity.

For example, it may include a polymer resin with a cation exchange group selected from the group consisting of a sulfonic acid group, a carboxylic acid group, a phosphoric acid group, a phosphonic acid group, and a derivative thereof, at the side chain.

The polymer resin may be, for example, a fluoro-based polymer, a benzimidazole-based polymer, a polyimide-based polymer, a polyetherimide-based polymer, a polyphenylenesulfide-based polymer, a polysulfone-based polymer, a polyethersulfone-based polymer, a polyetherketone-based polymer, a polyetheretherketone-based polymer, a polyphenylquinoxaline-based polymer, a copolymer thereof, and mixtures thereof. According to another embodiment, the polymer resin may be selected from the group consisting of poly(perfluorosulfonic acid) (in general, commercially available as NAFION®), poly(perfluorocarboxylic acid), a copolymer of tetrafluoroethylene including a sulfonic acid group and fluorovinylether, defluorinated polyetherketone sulfides, an aryl ketone, poly(2,2′-m-phenylene)-5,5′-bisbenzimidazole (poly (2,2′-(m-phenylene)-5,5′-bibenzimidazole), poly (2,5-benzimidazole), a copolymer thereof, and mixtures thereof.

In addition, the polymer resin can include a proton conductive polymer having, for example, Na, K, Li, Cs, or tetrabutylammonium substituted for H⁺ in the cation exchange group. When H⁺ is substituted for Na in the cation exchange group at the side chain, NaOH can be used. When H⁺ is substituted for tetrabutylammonium, tetrabutylammonium hydroxide can be used. When H+is substituted for K, Li, or Cs, an appropriate compound can be used. This substitution is well-known in a related field and needs no more detailed illustration.

Since the membrane-electrode assembly includes a hydrophilic organic compound layer, the hydrophilic organic compound layer can form a composition coating for an aqueous catalyst layer directly on an electrode substrate to form a catalyst layer, preventing possibility of fire due to use of an organic solvent and preventing distortion of a polymer electrolyte membrane, thereby securing excellent power characteristics.

According to the embodiment, a membrane-electrode assembly can be prepared by forming a microporous layer on an electrode substrate; forming a hydrophilic organic compound layer on the microporous layer; heat-treating the electrode substrate with the catalyst layer to remove the hydrophilic organic compound layer; and binding the electrode substrate without the hydrophilic organic compound layer and a polymer electrolyte membrane.

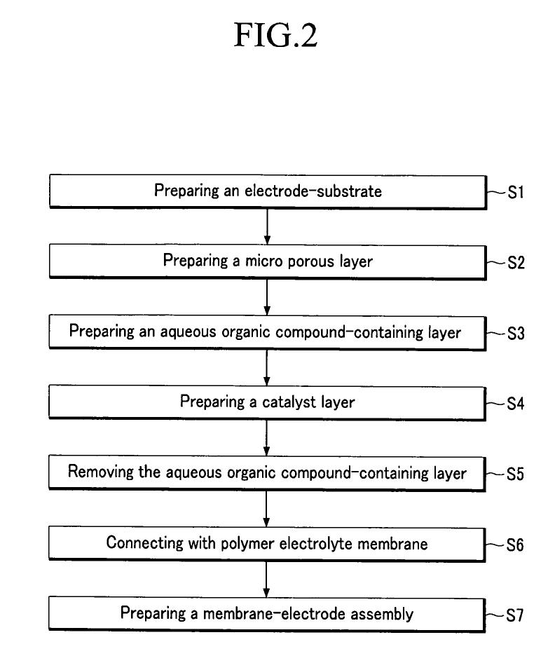

FIG. 2 is a schematic flow chart showing a method of manufacturing a membrane-electrode assembly according to one embodiment. Referring to FIG. 2, a method of manufacturing a membrane-electrode assembly according to one embodiment includes preparing an electrode substrate (S1); forming a microporous layer on the electrode substrate (S2); forming a hydrophilic organic compound layer on the microporous layer (S3); forming a catalyst layer on the hydrophilic organic compound layer (S4); heat-treating the electrode substrate with the catalyst layer to remove the hydrophilic organic compound layer (S5); and binding a polymer electrolyte membrane to the electrode substrate without the hydrophilic organic compound layer (S6).

Hereinafter, a method of manufacturing a membrane-electrode assembly is described in more detail. First, an electrode substrate is provided (S1).

The electrode substrate and the hydrophilic organic compound may be the same as aforementioned but can be subjected to a water-repellent treatment with a fluorine-based resin, so that water generated during operation of a fuel cell may not deteriorate diffusion efficiency of a reactant.

The fluorine-based resin may be the same as aforementioned, and the water-repellent treatment may include a common method such as impregnation, coating, and the like.

The electrode substrate may include a microporous layer at one side (S2).

The microporous layer can be formed by preparing a composition for a microporous layer including a conductive powder, a binder resin, and a solvent, and coating the composition on the electrode substrate.

The conductive powder and binder resin may be the same as aforementioned.

The solvent may include, for example, alcohols such as ethanol, isopropyl alcohol, n-propy lalcohol, butanol, and the like, water, dimethylacetamide, dimethylsulfoxide, or N-methylpyrrolidone, and the like.

The coating process may include screen printing, spray coating, or a doctor blade method depending on viscosity of a composition, but is not limited thereto.

A hydrophilic organic compound layer is formed on the microporous layer (S3).

The hydrophilic organic compound layer allows an aqueous composition for a catalyst layer to be easily coated on the electrode substrate.

The hydrophilic organic compound is hydrophilic and has sufficient viscosity to be coated on the microporous layer. According to one embodiment, the viscosity can be from about 0.7 to about 1.3 N·s/m². According to another embodiment, the viscosity can be from about 0.9 to about 1.1 N·s/m². When the hydrophilic organic compound has a viscosity within the ranges, it is easy to coat it and hydrophilic organic compound is completely volatilized during the volatilizing step.

According to one embodiment, the hydrophilic organic compound is selected from the group consisting of polyhydric alcohols, glycol derivatives, hyaluronic acids, and mixtures thereof, which have two or more hydroxyl groups. According to another embodiment, they have two to ten hydroxyl groups.

The polyhydric alcohols and glycol derivatives may include ethylene glycol, triethylene glycol, ethylene glycol monobutylether, acetic acid ethylene glycol monoethylether, glycerine, glycol ether, and so on.

According to one embodiment, the hyaluronic acid has a weight-average molecule weight (Da) of from about 250,000 to about 350,000 Da. According to another embodiment, the weight-average molecule weight ranges from about 300,000 to about 330,000 Da. When the weight-average molecule weight of the hyaluronic acid is within the ranges, it is easy to coat it and to be volatilized completely during the volatilizing step.

The hydrophilic organic compound layer is provided by impregnating an electrode substrate formed with a microporous layer in a liquid hydrophilic organic compound having a predetermined viscosity and drying the same, or alternatively, by coating a hydrophilic organic compound on an electrode substrate formed with a microporous layer and drying the same.

The coating process is selected from the group consisting of screen printing, spray coating, doctor blade coating, gravure coating, dip coating, silk screening, painting, and slot die coating depending upon the viscosity of the hydrophilic organic compound, but it is not limited thereto. According to one embodiment, it is coated by screen printing.

During the drying process, the loading amount of the hydrophilic organic compound is controlled on the hydrophilic electrode substrate. The drying process is performed by a conventional method such as natural drying or low temperature hot-air drying.

According to one embodiment, the hydrophilic organic compound is present at from about 0.3 mg/cm² to about 0.9 mg/cm² on the microporous layer after the drying process. According to another embodiment, the loading amount of the hydrophilic organic compound ranges from about 0.5 mg/cm² to about 0.7 mg/cm². When the loading amount of the hydrophilic organic compound is within the ranges, it is easy to coat the aqueous composition for the catalyst layer and the hydrophilic organic compound is completely volatilized during the volatilizing step. When the hydrophilic organic compound remains in the membrane-electrode assembly, the electrical conductivity is deteriorated, and the microporous layer pores are collapsed to deteriorate the mass transfer and a flooding phenomenon occurs in the electrode.

A catalyst layer is formed on the obtained hydrophilic organic compound layer (S4).

The catalyst layer is formed by coating an aqueous composition for a catalyst layer directly on the electrode substrate formed with the hydrophilic organic compound layer and drying the same, or alternatively, by transfer coating a catalyst layer on the electrode substrate.

The composition for the catalyst layer is an aqueous composition including the aqueous solvent and is obtained by dispersing a catalyst and a water-soluble binder in an aqueous solvent.

The catalyst and the water-soluble binder are identical to those mentioned above.

The aqueous solvent may include water. According to one embodiment, the aqueous solvent prevents a fire compared with the conventional organic solvent, and can provide a wider three phase boundary area with the catalyst than the conventional binder dispersing in the organic solvent since the aqueous binder has a shorter chain length.

The catalyst layer is provided by direct coating, in which a composition for a catalyst layer is coated directly on the electrode substrate formed with the hydrophilic organic compound layer and dried. The coating process may be, for example, screen printing, spray coating, doctor blade coating, gravure coating, dip coating, silk screening, painting, and slot die coating, but it is not limited thereto. According to one embodiment, it is coated by screen printing.

In the case of providing the catalyst layer by transfer coating, a composition for a catalyst layer is coated on one surface of a transfer substrate and dried to provide a catalyst layer, and is hot rolled to transfer it to the electrode substrate formed with the hydrophilic organic compound layer to provide the catalyst layer.

The transfer substrate for the catalyst layer includes any substrate from which the conventional catalyst layer is easily peeled. According to one embodiment, the transfer substrate includes a glass substrate or a releasing film. According to another embodiment, it includes a releasing film that facilitates smooth peeling of the catalyst layer without tearing.

The releasing film includes a fluorinated resin film such as polytetrafluoro ethylene (PTFE), tetrafluoro ethylene-hexafluoro propylene copolymer (FEP), tetrafluoro ethylene-perfluoroalkylvinylether copolymer (PFA), ethylene/tetrafluoroethylene (ETFE), polyvinylidene fluoride, and so on; or a non-fluorinate polymer film such as polyimide (Kapton®, manufactured by DuPont Inc., Wilmington, Del.), polyethylene, polypropylene, polyethylene terephthalate, polyester (Mylar®, manufactured by DuPont), and so on.

A process of coating the composition for the catalyst layer on the transfer substrate is undertaken as mentioned above.

The transfer coating process includes displacing the catalyst formed with the releasing film on the electrode substrate formed with the hydrophilic organic compound layer, hot rolling, and transferring the same. The hot rolling temperature ranges from about 70 to about 150° C. According to another embodiment, it ranges from about 80 to about 120° C. The hot rolling pressure ranges from about 300 to about 3000 psi. According to another embodiment, it ranges from about 1000 to about 1500 psi. When the temperature and pressure are within the ranges, the catalyst layer is easily transferred

The electrode substrate formed with the catalyst layer is subjected to the heat treatment to remove a hydrophilic organic compound layer (S5).

The heat treatment process is performed at a temperature ranging from about 160 to about 190° C. According to another embodiment, it ranges from about 170 to about 180° C. When the heat treatment is performed at a temperature of less than about about 160° C., it is hard to volatilize the hydrophilic organic compound. On the other hand, when it is more than about 190° C., the proton conductive polymer is decomposed in the catalyst layer to deteriorate proton conductivity.

According to one embodiment, the heat treatment process is performed under a vacuum atmosphere.

The hydrophilic organic compound layer is volatilized to assemble the electrode substrate including only the microporous layer and the catalyst layer with a polymer electrolyte membrane (S6) and to provide a membrane-electrode assembly (S7).

The polymer electrolyte membrane is identical to that mentioned above.

The process of assembling the electrode substrate including the microporous layer and catalyst layer with a polymer electrolyte membrane may be performed in accordance with the conventional method. Particularly, the electrode substrate including the microporous layer and the catalyst layer is displaced to face the catalyst layer to the polymer electrolyte membrane, and they are hot rolled to bind them to each other.

The hot rolling temperature ranges from about 70 to about 150° C. According to another embodiment, it ranges from about 80 to about 120° C. The hot rolling pressure ranges from about 700 to about 3000 psi. According to another embodiment, it ranges from about 1000 to about 1500 psi. When the temperature and the pressure are within the ranges, the electrode is effectively bound with the polymer electrolyte membrane.

The obtained membrane-electrode assembly prevents a fire since the aqueous solvent is used when the catalyst layer is formed, the manufacturing method thereof is simple since the composition for the catalyst layer is coated directly on the electrode substrate to provide a catalyst layer, and the polymer electrolyte membrane is less distorted to improve the cell characteristics of the fuel cell.

According to one embodiment, a method of manufacturing the membrane-electrode assembly includes providing a separate hydrophilic organic compound layer on the microporous layer and removing the same. Alternatively, instead of forming the separate hydrophilic organic compound layer, the membrane-electrode assembly may be obtained by mixing the hydrophilic organic compound with the composition for a microporous layer to provide a microporous layer, providing a catalyst layer, and heat treating to remove the hydrophilic organic compound in the microporous layer.

In addition, the present embodiments provide a fuel cell system including a membrane-electrode assembly according to the aforementioned method.

The fuel cell system includes the membrane-electrode assembly and at least one electricity generating element including a separator, a fuel supplier supplying a fuel to the electricity generating element, and an oxidant supplier supplying an oxidant to the electricity generating element.

The electricity generating element includes a membrane-electrode assembly and a separator (also called a bipolar plate), and it generates electricity through oxidation of a fuel and reduction of an oxidant.

The fuel supplier plays a role of supplying a fuel to the electricity generating element, and the oxidant supplier plays a role of supplying an oxidant such as oxygen or air to the electricity generating element. According to the embodiment of the present embodiments, the fuel includes hydrogen or a hydrocarbon fuel in gas or liquid form. The hydrocarbon fuel may include methanol, ethanol, propanol, butanol, or natural gas.

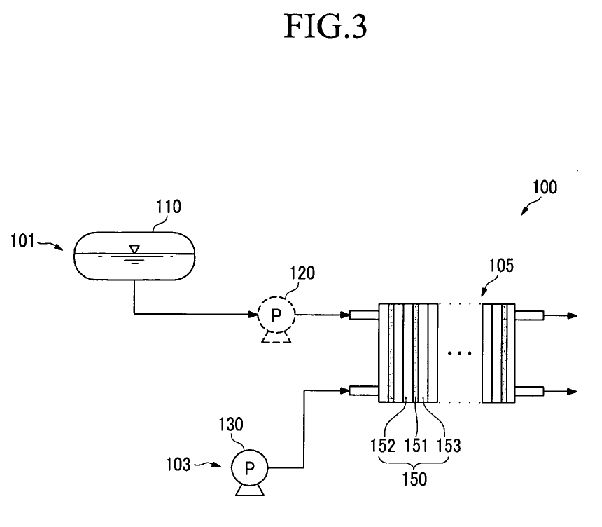

FIG. 3 shows a schematic structure of a fuel cell system according to the present embodiments, which will be described in details with the reference to -the accompanying drawing as follows. As shown in FIG. 3, a fuel and an oxidant are supplied to an electricity generating element by using a pump. However, the present embodiments are not limited thereto and can employ a diffusion method.

According to the embodiment, a fuel cell system 100 includes at least one electricity generating element 150 generating electricity through electrochemical reaction of a fuel and an oxidant, a fuel supplier 101 supplying the fuel to the electricity generating element 150, and an oxidant supplier 103 supplying the oxidant to the electricity generating element 150.

The fuel supplier 101 may include a fuel tank 110 storing a fuel and optionally a fuel pump 120 connected to the fuel tank 110. The fuel pump 120 plays a role of discharging a fuel stored in the fuel tank 1 10 with a predetermined pumping power.

Likewise, the oxidant supplier 103 supplying an oxidant to the electricity generating element 150 can include at least an oxidant pump 130 supplying an oxidant with a predetermined pumping power.

The electricity generating element 150 includes a membrane-electrode assembly 151 for oxidation and reduction of a fuel and an oxidant, and separators 152 and 153 at respective sides of the membrane-electrode assembly 151 for supplying the fuel and the oxidant. The electricity generating element 150 forms a stack either singularly or severally.

The following examples illustrate the present embodiments in more detail. However, it is understood that the present embodiments are not limited by these examples.

### EXAMPLE 1

A composition for a microporous layer was prepared by mixing 3.0 g of carbon black in 30 ml of isopropyl alcohol with 1.0 g of 10 wt % polytetrafluoroethylene, and then mechanically agitating them together. Next, a microporous layer was formed by coating the composition for a microporous layer on a carbon paper electrode substrate treated with TEFLON (tetrafluoroethylene) (SGL 31BC; SGL Carbon Group Co., Wiesbaden, Germany) in a screen-printing method and drying it.

Then, a hydrophilic organic compound layer was formed on the microporous layer of the electrode substrate by impregnating it with glycerine (viscosity: 1.0 N·s/m²). Herein, the hydrophilic organic compound was loaded at 0.5 mg/cm².

In addition, a composition for a cathode catalyst layer was prepared by mixing 10 g of 10 wt % NAFION® (DuPont Co.) aqueous dispersion solution with 3.0 g of Pt/C (20 wt %, E-tek Co., Somerset, N.J.) in 30 ml of water, and then mechanically agitating them together. Then, a cathode catalyst layer was formed on the hydrophilic organic compound layer of the electrode substrate by directly coating the composition for a cathode catalyst layer. Herein, the cathode catalyst layer was formed in a size of 5×5 cm², and the catalyst was loaded at 3 mg/cm².

Then, a cathode was prepared by heat-treating the electrode substrate with the cathode catalyst layer under a vacuum atmosphere at 180° C. for 2 hours to remove the hydrophilic organic compound layer.

On the other hand, an anode was prepared by using a PtRu black catalyst (HiSPEC 6000, Johnson Matthey Co., London, UK) and electrode substrate (SGL 10DA, SGL Carbon Group Co.) in the same method as aforementioned. Herein, the catalyst for the anode was loaded at 6 mg/cm².

Next, a membrane-electrode assembly was fabricated by positioning the prepared anode and cathode at respective sides of a polymer electrolyte membrane for a fuel cell (DuPont Co.; NAFION 115 Membrane), and then pressing it at 135° C. at 300 psi for 3 minutes.

The prepared membrane-electrode assembly was inserted between two gaskets and between two separators with gas and cooling channels. The resulting product was compressed between copper end plates, gaining a single cell.

### EXAMPLE 2

A single cell was fabricated according to the same method as in Example 1 except for using propylene glycol (viscosity: 0.8 N·s/m²) instead of glycerine as a hydrophilic organic compound.

### EXAMPLE 3

A single cell was fabricated according to the same method as in Example 1 except for using an electrode substrate made of carbon paper.

### EXAMPLE 4

A single cell was fabricated according to the same method as in Example 1 except for using hyaluronic acid (viscosity: 0.7 N·s/m²) with a weight average molecular weight (Da) of 250,000 as a hydrophilic organic compound and performing a drying process until a catalyst was loaded at 0.3 mg/cm².

### EXAMPLE 5

A single cell was fabricated according to the same method as in Example 1 except for using hyaluronic acid (viscosity: 1.3 N·s/m²) with a weight average molecular weight (Da) of 250,000 as a hydrophilic organic compound and performing a drying process until a catalyst was loaded at 0.9 mg/cm².

### EXAMPLE 6

A composition for a microporous layer was prepared by adding 1.0 g of 10 wt % polyperfluorosulfonylfluoride to 3.0 g of carbon nanotubes in 30 ml of dimethylacetamide with 1.0 g of 10 wt % polytetrafluoroethylene, and then mechanically agitating them together. Next, the composition for a microporous layer was coated on a carbon paper electrode substrate treated with TEFLON (tetrafluoroethylene) (cathode/anode=SGL 31BC; SGL carbon group Co.) in a screen-printing method and dried to form a microporous layer.

A hydrophilic organic compound layer was then formed on the microporous layer of the electrode substrate by spray-coating acetic acid ethyleneglycolmonoethylether (viscosity: 0.9 N·s/m²) and drying it. Herein, the hydrophilic organic compound was loaded at 0.7 mg/cm².

Then, a composition for a cathode catalyst layer was prepared by adding 10 g of 10 wt % NAFION® (DuPont Co.) aqueous dispersion solution to 3.0 g of Pt/C (20 wt %, E-tek Co.) in 30 ml of water and then, agitating them together. The composition for a cathode catalyst layer was coated on a polytetrafluoroethylene releasing film in a screen-printing method and then dried to form a catalyst layer.

This catalyst layer was placed to face the electrode substrate with the microporous layer. Then, they were hot-rolled together at 120° C. at 1500 psi to transfer the catalyst layer to the microporous layer. Herein, the cathode catalyst layer was formed with a size of 5×5 cm², and the catalyst was loaded at 3 mg/cm².

Then, the electrode substrate with the cathode catalyst layer was heat-treated under a vacuum atmosphere at 160° C. for 2 hours to remove the hydrophilic organic compound, fabricating a cathode.

On the other hand, an anode was prepared by using a PtRu black catalyst (HiSPEC 6000, Johnson Matthey Co.) and electrode substrate (SGL 10DA, SGL carbon group Co.) in the same method as aforementioned. Herein, the catalyst for the anode was loaded at 6 mg/cm².

The prepared anode and cathode were positioned at respective sides of a polymer electrolyte membrane for a fuel cell (DuPont Co.; NAFION 115 Membrane), and then compressed at 135° C. at 300 psi for 3 minutes, fabricating a membrane-electrode assembly.

The membrane-electrode assembly was inserted between two gaskets and two separators having gas and cooling channels with a predetermined shape, and then compressed between copper end plates, fabricating a single cell.

### EXAMPLE 7

A composition for a microporous layer was prepared by adding 1.0 g of 10 wt % polytetrafluoroethylene and acetic acid ethyleneglycolmonoethylether (viscosity: 1.1 N·s/m²) to 3.0 g of carbon black in 30 ml of water with 1.0 g of 10 wt % polytetrafluoroethylene, and then mechanically agitating them together. Next, the composition for a microporous layer was coated on a carbon paper electrode substrate treated with TEFLON (tetrafluoroethylene) (SGL 31BC; SGL carbon group Co.) in a screen-printing method and dried to form a microporous layer. Herein, a hydrophilic organic compound included in the microporous layer was loaded at 0.5 mg/cm².

In addition, a cathode catalyst layer was formed on the microporous layer of the electrode substrate by directly coating a composition for a cathode catalyst layer prepared by adding 10 g of 10 wt % NAFION® (DuPont Co.) aqueous dispersion solution to 3.0 g of 20 wt % Pt/C (E-tek Co.) in 30 ml of water, and then mechanically agitating them together. Herein, the cathode catalyst layer was formed in a size of 5×5 cm², and the catalyst was loaded at 3 mg/cm².

Then, the electrode substrate with the cathode catalyst layer was heat-treated under a vacuum atmosphere at 180° C. for 2 hours to evaporate a hydrophilic organic compound in the microporous layer, preparing a cathode.

On the other hand, an anode was prepared by using a PtRu black catalyst (HiSPEC 6000, Johnson Matthey Co.) and electrode substrate (SGL 10DA, SGL carbon group Co.) in the same method as aforementioned. Herein, the catalyst for the anode was loaded at 6 mg/cm².

The anode and the cathode were positioned at both sides of a polymer electrolyte membrane for a fuel cell (DuPont Co.; NAFION 115 Membrane). Then, they were pressed at 135° C. at 300 psi for 3 minutes, preparing a membrane-electrode assembly.

The membrane-electrode assembly was inserted between two gaskets and between two separators with gas and cooling channels having a predetermined shape, and then pressed between copper end plates, fabricating a single cell.

### COMPARATIVE EXAMPLE 1

A composition for a cathode catalyst layer was prepared by adding 10 g of 10 wt % NAFION® (DuPont Co.) dispersion solution to 3.0 g of 20 wt % Pt/C (E-tek Co.) in 30 ml of isopropyl alcohol and mechanically agitating them together. The composition for a cathode catalyst layer was directly coated on a carbon paper electrode substrate (SGL 31BC; SGL carbon group Co.) treated with TEFLON (tetrafluoroethylene) in a screen-printing method, preparing a cathode. Herein, the cathode catalyst layer was loaded in a size of 5×5 cm², and the catalyst was loaded at 3 mg/cm².

On the other hand, an anode was fabricated by using a PtRu black catalyst (HiSPEC 6000, Johnson Matthey Co.) and electrode substrate (SGL 10DA, SGL carbon group Co.) in the same method as aforementioned. Herein, the catalyst for the anode was loaded at 6 mg/cm².

Then, the anode and the cathode were positioned at respective sides of a polymer electrolyte membrane for a fuel cell (DuPont Co.; NAFION 115 Membrane), and then pressed at 135° C. at 300 psi for 3 minutes, preparing a membrane-electrode assembly.

The membrane-electrode assembly was inserted between two gaskets and between two separators with gas and cooling channels having a predetermined shape, and then pressed between copper end plates, fabricating a single cell.

### COMPARATIVE EXAMPLE 2

A hydrophilic organic compound layer was formed by impregnating one side of a carbon paper electrode substrate with glycerine (viscosity: 1.0 N·s/m²), and then drying it at 180° C. for 2 hours.

Then, a composition for a cathode catalyst layer was prepared by adding 10 g of 10 wt % NAFION® (DuPont Co.) aqueous dispersion solution to 3.0 g of 20 wt % Pt/C (E-tek Co.) in 30 ml of water, and then mechanically agitating them together. The composition for a cathode catalyst layer was directly coated on the hydrophilic organic compound layer of the electrode substrate, preparing a cathode. Herein, the cathode catalyst layer was formed in a size of 5×5 cm², and the catalyst was loaded at 3mg/cm².

On the other hand, an anode was prepared by using a PtRu black catalyst (HiSPEC 6000, Johnson Matthey Co.) in the same method as aforementioned. Herein, the catalyst for the anode was loaded at 6 mg/cm².

The cathode and the anode were positioned at respective sides of a polymer electrolyte membrane for a fuel cell (DuPont Co.; NAFION 115 Membrane), and then pressed at 135° C. at 300 psi for 3 minutes, preparing a membrane-electrode assembly.

The membrane-electrode assembly was inserted between two gaskets and between two separators with gas and cooling channels having a predetermined shape. Then, they were pressed between two copper end plates, fabricating a single cell.

### COMPARATIVE EXAMPLE 3

A composition for a cathode catalyst layer was prepared by adding 10 g of 10 wt % NAFION® (DuPont Co.) dispersion solution to 3.0 g of 20 wt % Pt/C (E-tek Co.) in 30 ml of isopropyl alcohol, and then mechanically agitating them together. The composition for a cathode catalyst layer was directly coated on a polymer electrolyte membrane for a fuel cell (DuPont Co.; NAFION 115 Membrane) in a screen-printing method to form a cathode catalyst layer. Herein, the cathode catalyst layer was formed in a size of 5×5 cm², and the catalyst was loaded at 3 mg/cm².

On the other hand, an anode catalyst layer was prepared by using a PtRu black catalyst (HiSPEC 6000, Johnson Matthey Co.) in the same method as aforementioned on the other side of a polymer electrolyte membrane. Herein, the catalyst layer for the anode was formed in a size of 6 mg/cm².

Then, a carbon paper electrode substrates treated with TEFLON® (tetrafluoroethylene) (cathode/anode=SGL 31BC/10DA; SGL carbon group Co.) were positioned at respective sides of a polymer electrolyte membrane having the cathode and anode catalyst layers. Then, they were pressed at 135° C. at 300 psi for 3 minutes, preparing a membrane-electrode assembly.

The membrane-electrode assembly was inserted between gaskets and between two separators with gas and cooling channels having a predetermined shape, and then pressed between copper end plates, fabricating a single cell.

The single cells according to Example I and Comparative Example 1 were measured regarding the average chain length of a binder resin included in the catalyst layer by using light scattering: ELS 9300 (Otsuka Electronics Co., Japan)

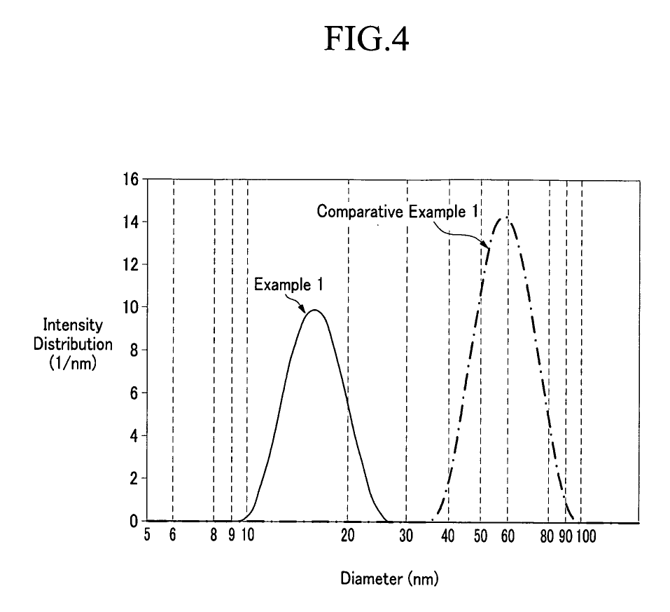

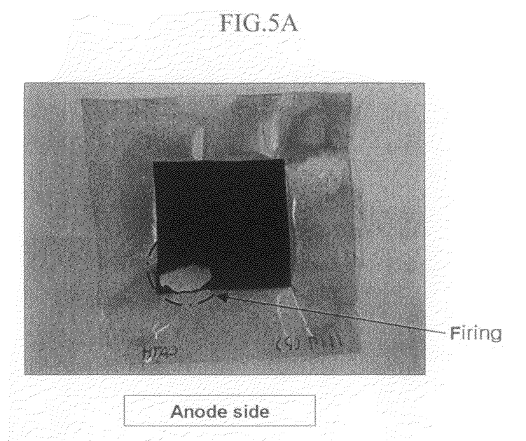

The results are shown in FIG. 4.

As shown in FIG. 4, the cell of Example 1, with a catalyst layer formed by using an aqueous composition for a catalyst layer, had an average chain length of a binder resin inside the catalyst layer of 18 nm, while that of Comparative Example 1, with a catalyst layer included an organic solvent of isopropyl alcohol, had an average chain length of a binder resin inside the catalyst layer of 59 nm. Despite the use of the same binder resin, the cell of Example 1 had a very small sized binder resin by dispersing the binder resin into an aqueous solvent, while that one of Comparative Example 1 had a larger size than the cell of Example 1 by dispersing a binder resin into an organic solvent.

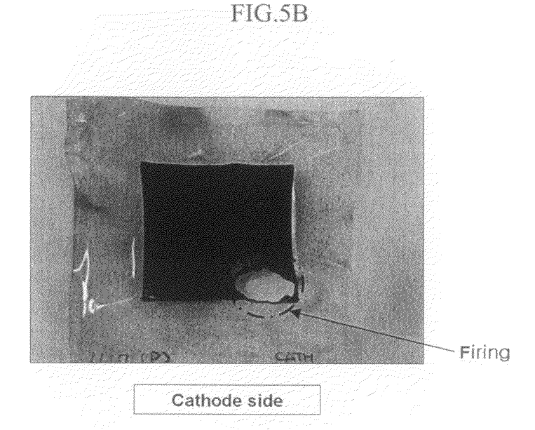

FIG. 5A is a photograph showing firing that occurred during the fabrication process of an anode catalyst layer on a membrane-electrode assembly according to Comparative Example 3, while FIG. 5B is a photograph showing firing that occurred during the fabrication process of an cathode catalyst layer on a membrane-electrode assembly according to Comparative Example 3.

As shown in FIG. 5A and 5B, the firing occurred while a composition for a catalyst layer including an organic solvent was coated on a polymer electrolyte membrane.

In addition, the single cells according to Examples 1 and 2 and Comparative Examples 1 and 2 were examined regarding current density under operation conditions of a direct oxidation fuel cell (hydrogen/air and 3M methanol/air). The results are shown in the following Table 1.

TABLE 1

| | Current density at 50° C. and 0.7 V (mA/cm²) |
|---|---|
| Example 1 | 350 |
| Example 2 | 300 |
| Comparative Example 1 | 80 |
| Comparative Example 2 | 250 |

As shown in Table 1, the single cells including a membrane-electrode assembly according to Examples 1 and 2 of the present embodiments had much better current density than those of Comparative Examples 1 and 2, and thereby excellent power characteristics under the same operation conditions (3M methanol/air at 50° C.).

In particular, since the cell of Comparative Example 1 did not include a hydrophilic organic compound layer but was fabricated by using a common oil-based catalyst slurry, its polymer electrolyte membrane was distorted, making current density lower than the cells of Examples 1 and 2. In addition, since the single cell of Comparative Example 2 includes a hydrophilic organic compound layer directly formed on an electrode substrate, the composition for an aqueous catalyst layer enters the electrode substrate, decreasing a reaction surface area and decreasing current density.

According to the embodiment, a membrane-electrode assembly can be easily prepared without firing and can be prevented from distorting, improving cell characteristics.

While the present embodiments have been described in connection with what is presently considered to be practical exemplary embodiments, it is to be understood that the present embodiments are not limited to the disclosed embodiments, but, on the contrary, is intended to cover various modifications and equivalent arrangements included within the spirit and scope of the appended claims.

What is claimed is:

1. A membrane-electrode assembly for a fuel cell, comprising:
an anode and a cathode facing each other; and
a polymer electrolyte membrane interposed therebetween,
wherein at least one of the anode and cathode comprises
an electrode substrate,
a microporous layer disposed on the electrode substrate, and
a catalyst layer disposed on the microporous layer, and
wherein the catalyst layer comprises a catalyst and a binder resin, and wherein the binder resin has an average chain length from about 5 nm to about 30 nm.

2. The membrane-electrode assembly of claim 1, wherein the binder resin has an average chain length from about 7 to about 20 nm.

3. The membrane-electrode assembly of claim 1, wherein the binder resin is a water-soluble binder.

4. The membrane-electrode assembly of claim 1, wherein the binder resin is a polymer resin having a cation exchange group selected from the group consisting of a sulfonic acid group, a carboxylic acid group, a phosphoric acid group, a phosphonic acid group, and derivatives thereof, at its side chain.

5. The membrane-electrode assembly of claim 1, wherein the catalyst is a platinum-based catalyst.

6. The membrane-electrode assembly of claim 1, wherein the catalyst is selected from the group consisting of platinum, ruthenium, osmium, platinum-ruthenium alloys, platinum-osmium alloys, platinum-palladium alloys, platinum-M alloys, combinations thereof, and mixtures thereof;
wherein M is a transition element selected from the group consisting of Ga, Ti, V, Cr, Mn, Fe, Co, Ni, Cu, Zn, Sn, Mo, W, Ru, Rh.

7. The membrane-electrode assembly of claim 1, wherein the catalyst is supported on a carrier selected from the group consisting of a carbon-based material, an inorganic material particulate, and mixtures thereof.

8. The membrane-electrode assembly of claim 1, wherein the catalyst layer further comprises a non-conductive compound.

9. The membrane-electrode assembly of claim 1, wherein the microporous layer comprises a conductive powder selected from the group consisting of carbon powders, carbon black, acetylene black, activated carbon, carbon fiber, fullerene, carbon nanotubes, carbon nanowire, carbon nanohoms, carbon nanorings, and mixtures thereof.

10. The membrane-electrode assembly of claim 1, wherein the electrode substrate is a conductive substrate selected from the group consisting of carbon paper, carbon cloth, carbon felt, metal cloth, and combinations thereof.

11. The membrane-electrode assembly of claim 1, wherein the electrode substrate is subjected to a water-repellent treatment with a fluorinated resin.

12. The membrane-electrode assembly of claim 1, wherein the polymer electrolyte membrane comprises a polymer resin having at its side chain a cation exchange group selected from the group consisting of a sulfonic acid group, a carboxylic acid group, a phosphoric acid group, a phosphonic acid group, and derivatives thereof.

13. A method of manufacturing a membrane-electrode assembly for a fuel cell, comprising:
forming a microporous layer on an electrode substrate;
forming a hydrophilic organic compound layer on the microporous layer;
forming a catalyst layer on the hydrophilic organic compound layer;
subjecting the electrode substrate to heat treatment to remove a hydrophilic organic compound layer; and
assembling the electrode substrate without the hydrophilic organic compound layer and a polymer electrolyte membrane.

14. The method of claim 13, wherein forming the hydrophilic organic compound layer is manufactured by a method comprising:
impregnating an electrode substrate with a microporous layer in a hydrophilic organic compound; and
drying the electrode substrate or;
coating a hydrophilic organic compound on an electrode substrate with a microporous layer and then drying the electrode substrate.

15. The method of claim 13, wherein the hydrophilic organic compound has viscosity from about 0.7 to about 1.3 N·s/m².

16. The method of claim 13, wherein the hydrophilic organic compound is selected from the group consisting of polyhydric alcohols with more than two hydroxyl groups, a glycol derivative, hyaluronic acid, and mixtures thereof.

17. The method of claim 16, wherein the hyaluronic acid has a weight-average molecule weight from about 250,000 to about 350,000 Da.

18. The method of claim 13, wherein the hydrophilic organic compound layer comprises a hydrophilic organic compound in an amount of about 0.3 mg/cm² to about 0.9 mg/cm² on a microporous layer.

19. The method of claim 13, wherein the composition for a catalyst layer comprises a catalyst, a binder resin, and an aqueous solvent.

20. The method of claim 19, wherein the aqueous solvent comprises water.

21. The method of claim 13, wherein the heat treatment is performed at a temperature from about 160 to about 190° C.

22. The method of claim 13, wherein the heat treatment is performed under a vacuum atmosphere.

23. The method of claim 13, wherein the electrode substrate is selected from the group consisting of carbon paper, carbon cloth, carbon felt, metal cloth, and combinations thereof.

24. The method of claim 13, wherein the electrode substrate is subjected to a water-repellent treatment with a fluorine-based resin.

25. A fuel cell system comprising:
a fuel supplier that supplies an electricity generating element with a fuel;
an oxidant supplier that supplies the electricity generating element with an oxidant; and
at least one electricity generating element comprising
a membrane-electrode assembly comprising an anode and a cathode facing each other, and a polymer electrolyte membrane interposed therebetween, and
a separator positioned at each side of the membrane-electrode assembly,
wherein at least one of the anode and cathode comprises
an electrode substrate,
a microporous layer disposed on the electrode substrate, and
a catalyst layer disposed on the microporous layer,
wherein the catalyst layer comprises a catalyst and a binder resin, and wherein the binder resin has an average chain length from about 5 to about 30 nm.
